(19) United States
(12) Patent Application Publication
(10) Pub. No.: US 2025/0139860 A1
(43) Pub. Date: May 1, 2025

(54) MATERIAL PREVIEW METHOD, MEDIUM, AND ELECTRONIC DEVICE

(71) Applicant: Beijing Youzhuju Network Technology Co., Ltd., Beijing (CN)

(72) Inventors: Chen LING, Beijing (CN); Chengkai PENG, Beijing (CN); Enbei ZHANG, Beijing (CN); XianZhe YUE, Beijing (CN); Zhi ZHANG, Beijing (CN); Yuanyu GAO, Beijing (CN); Chen WANG, Beijing (CN); Junchen LIU, Beijing (CN); Bingfeng ZHU, Beijing (CN); Zhixiao CHEN, Beijing (CN); Xinxin XU, Beijing (CN); Chuanping WANG, Beijing (CN); Lihong SHI, Beijing (CN); Lei XIE, Beijing (CN); Xiaoguang ZHANG, Beijing (CN); Junhao NIE, Beijing (CN)

(21) Appl. No.: 18/927,796

(22) Filed: Oct. 25, 2024

(30) Foreign Application Priority Data
Oct. 26, 2023 (CN) 202311402659.5

(51) Int. Cl. G06T 11/60; G06F 8/65

(52) U.S. Cl. CPC G06T 11/60; G06F 8/65

(57) ABSTRACT

A material preview method, a medium and an electronic device are provided. The method includes: acquiring a material to be previewed and target preview information, wherein the target preview information comprises a target cloud real machine and an application for showing the material to be previewed, and a target showing style in which the application shows the material to be previewed; and rendering, according to the target cloud real machine and the application in combination with the target showing style, the material to be previewed to obtain a target preview content, wherein the target preview content is to be shown on a terminal device.

### CROSS-REFERENCE TO RELATED APPLICATION

This application claims priority to Chinese Patent Application No. 202311402659.5, filed on Oct. 26, 2023, the entire disclosure of which is incorporated herein by reference as part of the present disclosure.

### TECHNICAL FIELD

The present disclosure relates to a material preview method, a medium, and an electronic device.

### BACKGROUND

Before a page is launched or posted, the page usually needs to be verified or tested. In the related art, generally, page styles for different models and different systems are designed by the testing personnel, and then a user may add corresponding materials to the page. However, this way requires the testing personnel to develop various different specific page styles, and the user is required to replace a material with a material needing to be tested in each test. Consequently, every time when the material is changed, the user needs to manually preview the material, leading to low work efficiency.

### SUMMARY

Embodiments of the present disclosure provide a material preview method, performed by a server and comprising: acquiring a material to be previewed and target preview information, wherein the target preview information comprises a target cloud real machine and an application for showing the material to be previewed, and a target showing style in which the application shows the material to be previewed; and rendering, according to the target cloud real machine and the application in combination with the target showing style, the material to be previewed to obtain a target preview content, wherein the target preview content is to be shown on a terminal device.

In an embodiment, the material to be previewed and the target preview information are sent by the terminal device to the server, the target cloud real machine is in an internal network, and the terminal device is in an external network; the acquiring a material to be previewed and target preview information comprises: receiving, by an external service layer, the material to be previewed and the target preview information sent by the terminal device through a front end interface; and the rendering, according to the target cloud real machine and the application in combination with the target showing style, the material to be previewed to obtain a target preview content comprises: pushing the material to be previewed and the target showing style to the target cloud real machine by the external service layer, and calling the target cloud real machine to render the material to be previewed with the application and the target showing style so as to obtain the target preview content; the material preview method further comprises: receiving, by the external service layer, the target preview content sent by the target cloud real machine; and sending, by the external service layer, the target preview content to the front end interface of the terminal device to allow the terminal device to show the target preview content.

In an embodiment, the material to be previewed and the target preview information are sent by the terminal device to the server; the material preview method further comprises: determining a user state of the target cloud real machine according to a mapping relationship between a cloud real machine and a terminal device; when the use state represents that the target cloud real machine is in an idle state, allocating the target cloud real machine to the terminal device, and storing a mapping relationship between the target cloud real machine and the terminal device; and when the target cloud real machine is no longer used by the terminal device, canceling the mapping relationship between the target cloud real machine and the terminal device.

In an embodiment, the material preview method further comprises: updating a version of an application installed in the target cloud real machine and logging in to the updated application.

Embodiments of the present disclosure further provide a material preview method, performed by a terminal device and comprising: determining a material to be previewed and target preview information, wherein the target preview information comprises a target cloud real machine and an application for showing the material to be previewed, and a target showing style in which the application shows the material to be previewed; sending the material to be previewed and the target preview information to a server, wherein the server is configured to render, according to the target cloud real machine and the application indicated by the target preview information in combination with the target showing style, the material to be previewed to obtain a target preview content, and send the target preview content to the terminal device; and receiving the target preview content sent by the server, and showing the target preview content.

In an embodiment, the target cloud real machine is in an internal network, and the terminal device is in an external network; the sending the material to be previewed and the target preview information to a server comprises: sending the material to be previewed and the target preview information to an external service layer of the server through a front end interface, wherein the external service layer is configured to push the material to be previewed and the target showing style to the target cloud real machine, and call the target cloud real machine to render the material to be previewed with the application and the target showing style so as to obtain the target preview content; and the receiving the target preview content sent by the server comprises: receiving, through the front end interface, the target preview content sent by the external service layer of the server.

In an embodiment, the determining a material to be previewed and target preview information comprises: showing a target interface, wherein the target interface at least comprises a candidate showing style, a material input control, and a cloud real machine option; determining the target showing style according to a selected candidate showing style in response to a style configuration instruction; determining the material to be previewed according to a material uploaded to the material input control in response to a material input instruction; and determining the target cloud real machine in response to a selection instruction for the cloud real machine option.

In an embodiment, the material to be previewed comprises an image; and the material input control comprises a sub-control for configuring images having different resolutions that is supported by the target showing style.

Embodiments of the present disclosure further provide a material preview method, applied to a material preview system comprising a terminal device and a server, the material preview method comprising: determining, by the terminal device, a material to be previewed and target preview information, wherein the target preview information comprises a target cloud real machine and an application for showing the material to be previewed, and a target showing style in which the application shows the material to be previewed; sending, by the terminal device, the material to be previewed and the target preview information to the server; receiving, by the server, the material to be previewed and the target preview information sent by the terminal device; rendering, by the server according to the target cloud real machine and the application in combination with the target showing style, the material to be previewed to obtain a target preview content; sending, by the server, the target preview content to the terminal device; and receiving, by the terminal device, the target preview content sent by the server, and showing the target preview content.

Embodiments of the present disclosure further provide a non-transitory computer-readable medium, storing a computer program which, when executed by a processor, causes the material preview method provided by any one of the above embodiments to be implemented.

Embodiments of the present disclosure further provide an electronic device, comprising: a memory on which a computer program is stored; and a processor configured to execute the computer program on the memory to implement a material preview method provided by any one of the above embodiments.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a block diagram of a material preview system illustrated according to an exemplary embodiment.

FIG. 2 is a flowchart of a material preview method illustrated according to an exemplary embodiment.

FIG. 3 is a schematic diagram of a target preview content illustrated according to an exemplary embodiment.

FIG. 4 is a flowchart of interaction between a terminal device and a server illustrated according to an exemplary embodiment.

FIG. 5 is a schematic diagram of a target interface illustrated according to an exemplary embodiment.

FIG. 6 is a schematic diagram of interaction between a terminal device and a server illustrated according to an exemplary embodiment.

FIG. 7 is a flowchart of a material preview method illustrated according to another exemplary embodiment.

FIG. 8 is a flowchart of a material preview method illustrated according to yet another exemplary embodiment.

FIG. 9 is a schematic diagram of module connection of a material preview apparatus illustrated according to an exemplary embodiment.

FIG. 10 is a schematic diagram of module connection of a material preview apparatus illustrated according to an exemplary embodiment.

FIG. 11 is a structural schematic diagram of an electronic device illustrated according to an exemplary embodiment.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

Names of messages or information exchanged between a plurality of apparatuses in embodiments of the present disclosure are only used for the purpose of description and not meant to limit the scope of these messages or information.

It will be understood that before using the technical solutions disclosed in various embodiments of the present disclosure, a user should be notified of a type, a range of use, a usage scenario, etc. of personal information involved in the present disclosure in an appropriate manner in accordance with relevant laws and regulations, and these should be authorized by the user.

For example, in response to receiving an active request from a user, a prompt message is sent to the user to explicitly prompt the user that the operation the user requests to perform will require to acquire and use the personal information of the user. Thus, the use can independently select, according to the prompt message, whether or not to provide the personal information to software or hardware such as an electronic device, an application, a server or a memory medium that performs the operations of the technical solutions of the present disclosure.

As an alternative but non-limiting implementation, in response to receiving an active request from a user, a manner of sending a prompt message to the user may be, for example, using a pop-up window in which the prompt message may be presented in the form of text. Furthermore, the pop-up window may also carry option controls for a user to select to “agree” or “disagree” with providing personal information to an electronic device.

It will be understood that the processes of notifying of and authorizing by a user described above are merely exemplary and do not constitute a limitation on the implementations of the present disclosure, and other manners meeting relevant laws and regulations may also be applied to the implementations of the present disclosure.

Meanwhile, it will be understood that data (including but not limited to data itself, and the acquisition and use of data) involved in the present technical solutions should follow corresponding laws and regulations and requirements of relevant stipulations.

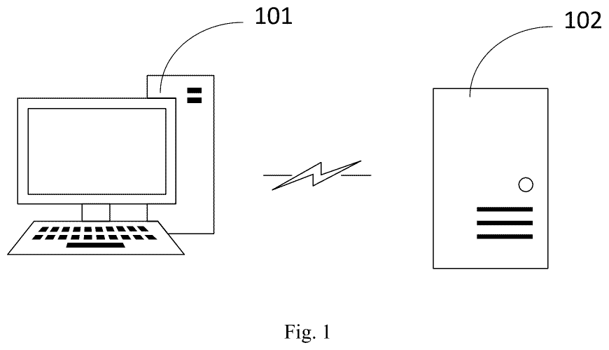

FIG. 1 is a block diagram of a material preview system illustrated according to an exemplary embodiment. As shown in FIG. 1, a material preview method provided by an embodiment of the present disclosure is applicable to the system shown in FIG. 1. The system may at least include a terminal device 101 and a server 102. Data interaction may be carried out by means of wired connection or wireless connection between the terminal device 101 and the server 102.

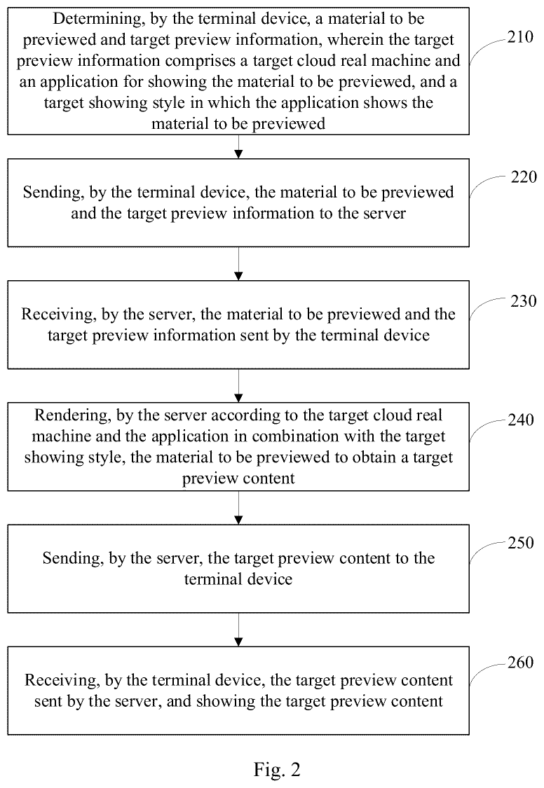

FIG. 2 is a flowchart of a material preview method illustrated according to an exemplary embodiment. As shown in FIG. 2, an embodiment of the present disclosure provides a material preview method which can be applied to the material preview system shown in FIG. 1. As shown in FIG. 2, the material preview method may include the following steps.

In step 210, the terminal device determines a material to be previewed and target preview information, wherein the target preview information includes a target cloud real machine and an application for showing the material to be previewed, and a target showing style in which the application shows the material to be previewed.

Here, the material to be previewed may be a content needing to be previewed by a user. The material to be previewed may be a content such as a picture, a text, and a video. The target cloud real machine refers to a target device selected by the user to simulate a page. It should be understood that a cloud real machine may be a virtual device constructed by the server using the virtual machine technique or a real device in communication connection with the server, such as a mobile terminal. The cloud real machine deployed in the server can simulate corresponding functions of a real device in the reality. The application may refer to an application selected by the user to simulate a page showing effect. The target showing style may refer to a page of the application that is used to show the material to be previewed. For example, the target showing style may refer to a launch screen page of the application, a content page of the application, and the like.

It is to be noted that the target preview information is used to instruct the server to simulate a showing effect of the material to be previewed in the target showing style of the application by the application on the target cloud real machine.

The user can input the material to be previewed on the terminal device and select the corresponding target preview information on the terminal device. Exemplarily, different types of cloud real machines may be deployed in the server, and the user can select the desired cloud real machine for effect simulation as the target cloud real machine. As a matter of course, a cloud real machine may also be solely deployed in a cloud server. The server, after receiving the material to be previewed and the target preview information, may send the material to be previewed and the target preview information to the cloud server to call the target cloud real machine in the cloud server to generate the target preview content. In addition, various types of applications may also be deployed in the target cloud real machine, or when the user previews the material, the target cloud real machine is instructed to install the corresponding application.

In step 220, the terminal device sends the material to be previewed and the target preview information to the server.

Here, the terminal can send the material to be previewed and the target preview information to the server by means of the communication connection between the terminal device and the server.

In step 230, the server receives the material to be previewed and the target preview information sent by the terminal device.

Here, the server may receive the material to be previewed and the target preview information sent by the terminal device by means of the communication connection between the server and the terminal device.

In step 240, the server renders the material to be previewed according to the target cloud real machine and the application in combination with the target showing style to obtain a target preview content.

Here, the server, after receiving the target preview information, calls the target cloud real machine indicated in the target preview information to simulate the showing effect of the material to be previewed in the target showing style indicated in the target preview information by the application indicated in the target preview information, thereby obtaining the target preview content.

It should be understood that the target cloud real machine can replace the material in the target showing style of the application with the material to be previewed and control the application to render and output a page corresponding to the target showing style with the replaced material.

In some embodiments, the server pushes the material to be previewed to the target cloud real machine, and controls the application to load the material to be previewed to the page corresponding to the target showing style in real time, and controls the application to render the material to be previewed to obtain the target preview content.

The server pushes the material to be previewed to the target cloud real machine, and the application running on the target cloud real machine loads the material to be previewed to the page corresponding to the target showing style in real time, and renders the page to obtain the target preview content.

It should be understood that the application running on the target cloud real machine directly loads the material to be previewed to the page corresponding to the target showing style in real time. Instead of firstly caching the material to be previewed using a caching strategy, the material to be previewed is directly loaded to the page corresponding to the target showing style, whereby the speed of preview is increased.

Taking the launch screen page of the application as an example, in actual use of the application, the launch screen page of the application generally caches the material to be previewed first, and then the material to be previewed is rendered in the launch screen page. By contrast, the application on the target cloud real machine no longer caches the material to be previewed, and instead, performs direct rendering to obtain the target preview content.

In step 250, the server sends the target preview content to the terminal device.

Here, the server, after obtaining the target preview content, sends the target preview content to the terminal device. It should be understood that the target preview content may be construed as a content of the showing effect of showing, by the user, the material to be previewed in the target showing style in the application of the target cloud real machine.

In step 260, the terminal device receives the target preview content sent by the server and shows the target preview content.

Here, the terminal device may receive the target preview content sent by the server by means of the communication connection with the terminal device and the server, and show the target preview content on the terminal device so as to simulate the showing effect of the material to be previewed in the target showing style of the application on the target cloud real machine with the target preview content. It should be understood that since the target cloud real machine is equivalent to a real device in the real world, the server can simulate the showing effect of the material to be previewed on the real device with the target preview content obtained by the target cloud real machine, thereby realizing a real material preview.

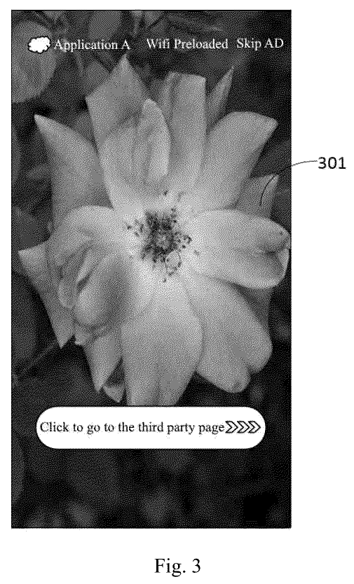

FIG. 3 is a schematic diagram of a target preview content illustrated according to an exemplary embodiment. The target cloud real machine is device A, the application is application A, the target showing style is the launch screen of the application A, and the material to be previewed is picture 301. As shown in FIG. 3, the target preview content shows the showing effect of the picture 301 in the launch screen page of the application A on the device A.

Thus, the material to be previewed and the target preview information are determined by the terminal device. The terminal device sends the material to be previewed and the target preview information to the server, and the server receives the material to be previewed and the target preview information sent by the terminal device, and renders, according to the target cloud real machine and the application in combination with the target showing style, the material to be previewed to obtain the target preview content. The server then sends the target preview content to the terminal device, and the terminal device receives the target preview content sent by the server and shows the target preview content. As a result, the showing effect of the material to be previewed can be simulated on the real device, and by configuring the target preview information, the user can simulate the showing effects of the material to be previewed on different devices, by different applications, and in different showing styles. There is no need to perform superfluous operation, and the material previewing efficiency is greatly improved. In addition, by the material preview method provided by the embodiment of the present disclosure, the developer of the application does not need to develop and design corresponding preview pages for different showing styles, and the long-term maintenance cost is extremely low.

In some achievable implementations, the target cloud real machine can be within an internal network, and the terminal device may be within an external network. Correspondingly, the terminal device sends the material to be previewed and the target preview information to an external service layer of the server through a front end interface, and the server receives the material to be previewed and the target preview information by the external service layer. The server pushes the material to be previewed and the target showing style to the target cloud real machine by the external service layer, and calls the target cloud real machine to render the material to be previewed with the application and the target showing style so as to obtain the target preview content. The server receives the target preview content sent by the target cloud real machine by the external service layer. The server sends the target preview content to the front end interface of the terminal device by the external service layer.

Here, since the target cloud real machine runs over the internal network and the terminal device is in the external network, in order to guarantee the safety of the target cloud real machine and realize interaction between the target cloud real machine and the terminal device, the external service layer may be disposed in the server. The external service layer is responsible for receiving data and instructions sent by the terminal device, and distributing the data and the instructions to the target cloud real machine, thereby avoiding the terminal device from directly controlling the target cloud real machine.

The external service layer may be construed as a software module disposed on the server and configured to interact with an external network device. That is, the external service layer receives the data and the instructions sent by the front end interface, and enables passthrough of the data and the instructions to the target cloud real machine, and the external service layer receives the data sent by the target cloud real machine and distributes the data to the front end interface. The front end interface may be a software development kit (SDK) interface provided by the server and configured for the terminal device to send the data and the instructions to the server.

The external service layer is in communication connection with the front end interface. Exemplarily, the external service layer may communicate with the front end interface by WebSocket (a protocol of full-duplex communication over a single TCP connection). The external service layer may also be in communication connection with the target cloud real machine. Exemplarily, the external service layer may be in communication connection with the target cloud real machine by WebSocket.

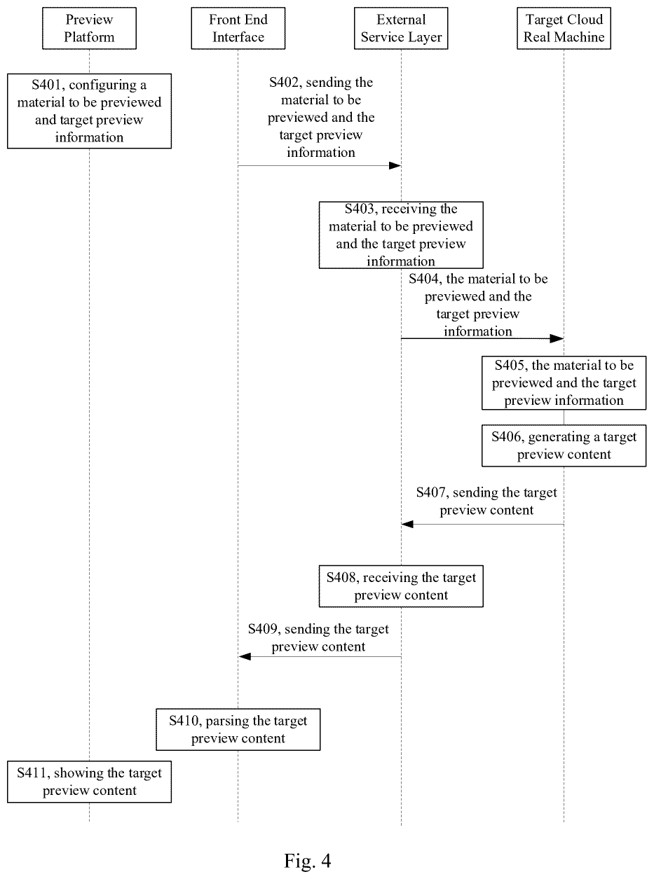

FIG. 4 is a flowchart of interaction between a terminal device and a server illustrated according to an exemplary embodiment. As shown in FIG. 4, the interaction may include the following steps:
S401, configuring, by a preview platform of the terminal device, a material to be previewed and target preview information;
S402, sending, by the terminal device through a front end interface, the material to be previewed and the target preview information to an external service layer of the server;
S403, receiving, by the external service layer of the server, the material to be previewed and the target preview information;
S404, sending, by the external service layer, the material to be previewed and the target preview information to a target cloud real machine;
S405, receiving, by the target cloud real machine, the material to be previewed and the target preview information;
S406, generating, by the target cloud real machine according to the material to be previewed and the target preview information, a target preview content;
S407, sending, by the target cloud real machine, the target preview content, to the external service layer;
S408, receiving, by the external service layer, the target preview content;
S409, sending, by the external service layer, the target preview content to the front end interface;
S410, receiving and parsing, by the front end interface, the target preview content; and
S411, showing, by the preview platform, the target preview content.

It is to be noted that in addition to data interaction with the front end interface, the external service layer of the server may also authenticate the terminal device, and allow the terminal device to access the server after authentication is successful. For terminal devices corresponding to different service lines, different authentication ways may be used to authenticate the terminal devices.

As a matter of course, the external service layer may restrict the control of the terminal device on the target cloud real machine by verifying the front end interface and configuring a command white list, thereby guaranteeing the safety of the material preview system.

Thus, with the external service layer deployed on the server, it can be realized that the terminal device within an external network can access a cloud real machine within an internal network, and by the external service layer, the control of the terminal device on the cloud real machine can be restricted to guarantee the safety of the internal network environment.

In some achievable implementations, the server determines a user state of the target cloud real machine according to a mapping relationship between a cloud real machine and a terminal device. When the user state represents that the target cloud real machine is in an idle state, the server allocates the target cloud real machine to the terminal device and stores a mapping relationship between the target cloud real machine and the terminal device. If the target cloud real machine is no longer used by the terminal device, the server cancels the mapping relationship between the target cloud real machine and the terminal device.

Here, the mapping relationship between the cloud real machine and the terminal device is used to represent whether the cloud real machine is occupied by the terminal device. When the cloud real machine is applied for and used by the terminal device, the server establishes the mapping relationship between the cloud real machine and the terminal device to represent that the cloud real machine is occupied by the terminal device.

The server may store the mapping relationship in a database. Exemplarily, the database may be a remote dictionary server (Redis). Other servers in the material preview system can query the mapping relationship in the database to determine the use state of the target cloud real machine applied by the terminal device according to the queried mapping relationship.

When the mapping relationship between the target cloud real machine and the terminal device is stored in the database, it represents that the use state of the target cloud real machine is an occupied state. When no mapping relationship between the target cloud real machine and the terminal device is stored in the database, it represents that the use state of the target cloud real machine is the idle state.

When the target cloud real machine is in the idle state, the server allocates the target cloud real machine applied by the terminal device to the terminal device, and stores the mapping relationship between the target cloud real machine and the terminal device to indicate to the other servers that the target cloud real machine has been occupied by the terminal device, preventing other servers from allocating the target cloud real machine to other terminal device.

When the target cloud real machine is no longer used by the terminal device using the target cloud real machine, the server cancels the mapping relationship between the target cloud real machine and the terminal device to indicate to other servers that the target cloud real machine has been released to be in the idle state and can be allocated to other terminal device for use.

It should be understood that the mapping relationship may be an association relationship between an identify label of the terminal device within the external network and a serial number of the cloud real machine.

Thus, with the mapping relationship described above, it can be avoided that the same cloud real machine is allocated to different terminal devices for use due to inconsistency of multi-room storage, and the accuracy of previewing a material by the cloud real machine can be guaranteed.

It is to be noted that the terminal device, before sending the material to be previewed, may apply for the target cloud real machine in advance and select the application. For example, before beginning to preview, the user may select the target cloud real machine and the application corresponding to a real device and needing to be simulated in advance, and send an instruction for requesting to use the target cloud real machine to the server. The server queries the use state of the target cloud real machine according to the mapping relationship in response to the instruction, and allocates the target cloud real machine to the terminal device when the user state is the idle state, and downloads the application needing to be simulated to the target cloud real machine. Moreover, the server updates the mapping relationship between the target cloud real machine and the terminal device to indicate that the target cloud real machine is occupied.

In some achievable implementations, the server may also update a version of the application installed in the cloud real machine and log in to the updated application.

Here, the server may also regularly update the version of the application installed in the cloud real machine to guarantee that the application can be of the latest version, thereby ensuring that the material previewing effect can be consistent with the showing effect in reality. Moreover, after the version of the application installed in the cloud real machine is updated, the server may also automatically log in to the updated application to guarantee that the user can no longer need to log in manually.

Thus, by updating the version of the application installed in the cloud real machine and logging in to the updated application, it not only can guarantee that the material previewing effect can be consistent with the showing effect in reality, but also the user does not need to log in manually, thereby guaranteeing the material previewing efficiency.

In some achievable implementations, the terminal device may show a target interface, wherein the target interface at least includes a candidate showing style, a material input control, and a cloud real machine option. The terminal device may determine the target showing style according to the selected candidate showing style in response to a style configuration instruction; and the terminal device may determine the material to be previewed according to a material uploaded to the material input control in response to a material input instruction; and the terminal device may determine the target cloud real machine in response to a selection instruction for the cloud real machine option.

Here, the terminal device may show the target interface by the preview platform. The target interface includes at least the candidate showing style, the material input control, and the cloud real machine option. The user may configure the target preview information and input the material to be previewed through the target interface.

It is to be noted that the user can select the application needing to perform material simulation in advance. For example, when the user needs to inject an advertisement to the application A, the user may select the application A on the terminal device in advance. All candidate showing styles provided by the application A may be then shown on the target interface.

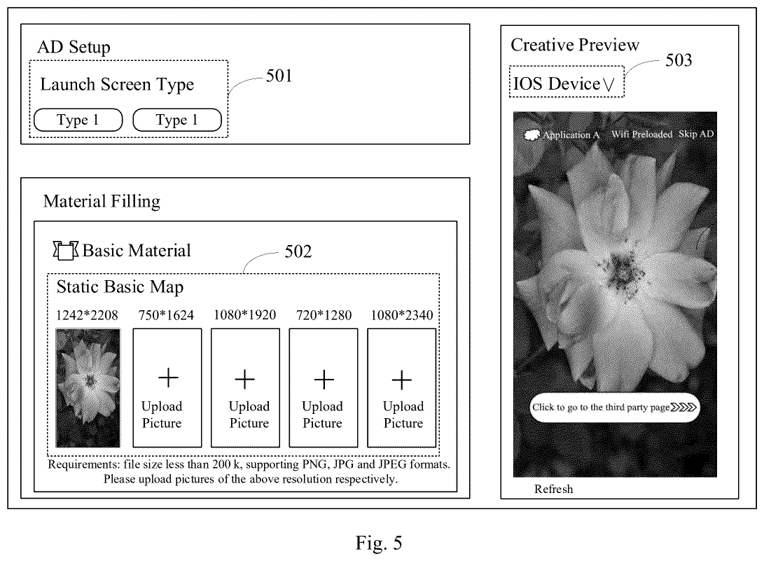

FIG. 5 is a schematic diagram of a target interface illustrated according to an exemplary embodiment. As shown in FIG. 5, the target interface may include a candidate showing style 501, a material input control 502, and a cloud real machine option 503. The user may select as a target showing style a showing style needing to be simulated in the candidate showing style 501 according to a style configuration instruction. The user may also determine a material uploaded to the material input control 502 as the material to be previewed according to a material input instruction. The user may further select a target cloud real machine in a cloud real machine list of the cloud real machine option 503 by a selection instruction.

It should be understood that in the practical use process, the material input control corresponding to the target showing style may be shown after the user selects the target showing style. For different target showing styles, there may be correspondingly different material input controls. For example, a video may be input for some target showing styles, a picture may be input for some target showing styles, and a text may be input for some target showing styles, etc.

As a matter of course, in other implementations, the target interface may also include an application list, and the terminal device may determine the application in response to a selection instruction of the application list.

In some embodiments, the material to be previewed includes an image; and correspondingly, the material input control includes a sub-control for configuring images having different resolutions that is supported by the target showing style.

As shown in FIG. 5, a launch screen type selected by the user is “launch screen type 1”, the material input control 502 may include a sub-control of resolution 1242*2208, a sub-control of resolution 750*1624, a sub-control of resolution 1080*1920, a sub-control of resolution 720*1280, and a sub-control of resolution 1080*2340. By the sub-controls, the user can input image materials of various resolutions supported by the “launch screen type 1” so as to simulate the showing effects of the image materials of different resolutions in the launch screen of the application.

Thus, by the target interface, the user can optionally configure the showing style needing to be simulated and select the corresponding cloud real machine so that the showing effect of the material to be previewed can be simulated on the real device, and the user does not need to perform superfluous operation, whereby the material previewing efficiency is greatly improved.

It is to be noted that the target page may also include a preview control, and the target preview content is shown in the preview control so that the user can view the showing effect of the material to be previewed in real time.

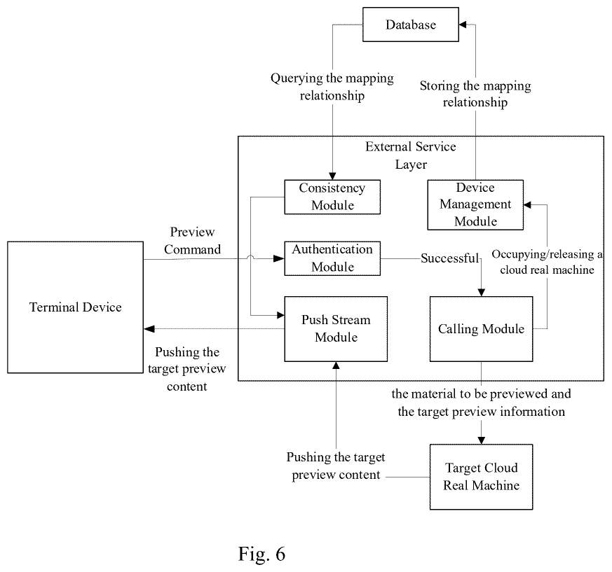

FIG. 6 is a schematic diagram of interaction between a terminal device and a server illustrated according to an exemplary embodiment. As shown in FIG. 6, the terminal device sends a preview command to an external service layer of the server, and the external service layer verifies the validity of the terminal device by an authentication module, and allocates a target cloud real machine to the terminal device by a calling module when authentication is successful. The calling module pushes a material to be previewed and target preview information to the target cloud real machine, and the target cloud real machine generates a target preview content according to the material to be previewed and the target preview information and pushes the target preview content to a push stream module. The push stream module pushes the target preview content to the terminal device, and the terminal device renders and outputs the target preview content. In addition, the calling module further synchronizes information that the terminal device occupies/releases a cloud real machine to a device management module, and the device management module stores or deletes a mapping relationship between the terminal device and the cloud real machine in a database according to the information of occupying/releasing the cloud real machine. A consistency module queries the mapping relationship in the database to determine a use state of the cloud real machine so as to provide an available cloud real machine to the terminal device.

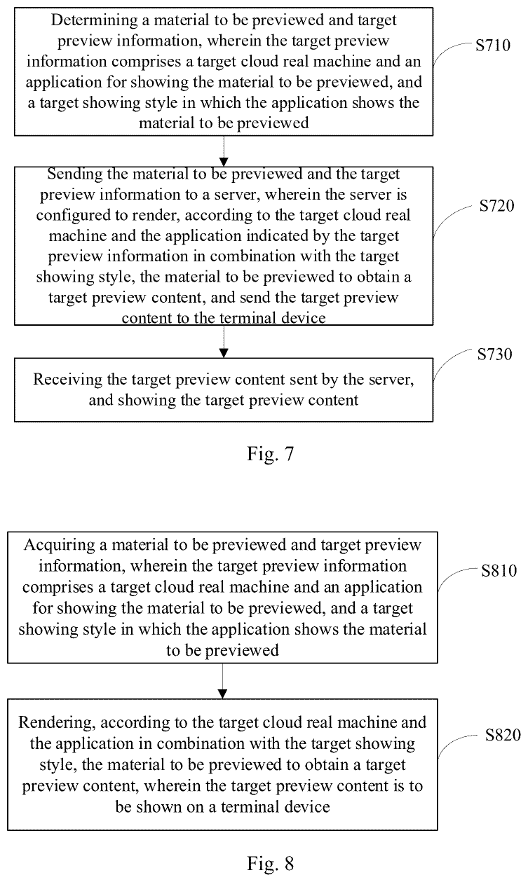

FIG. 7 is a flowchart of a material preview method illustrated according to another exemplary embodiment. As shown in FIG. 7, an embodiment of the present disclosure provides a material preview method which may be performed by the terminal device shown in FIG. 1, particularly by a material preview apparatus which may be implemented by software and/or hardware and configured in the terminal device. As shown in FIG. 7, the material preview method may include the following steps:
S710, determining a material to be previewed and target preview information, wherein the target preview information includes a target cloud real machine and an application for showing the material to be previewed, and a target showing style in which the application shows the material to be previewed;
S720, sending the material to be previewed and the target preview information to a server, wherein the server is configured to render, according to the target cloud real machine and the application indicated by the target preview information in combination with the target showing style, the material to be previewed to obtain a target preview content, and send the target preview content to the terminal device; and
S730, receiving the target preview content sent by the server, and showing the target preview content.

In some achievable implementations, the target cloud real machine is within an internal network, and the terminal device is within an external network. Correspondingly, in S720, the terminal device may send the material to be previewed and the target preview information to the external service layer of the server through a front end interface, wherein the external service layer is configured to push the material to be previewed and the target showing style to the target cloud real machine, and call the target cloud real machine to render the material to be previewed by the application and in the target showing style so as to obtain the target preview content. In S730, the terminal device may receive the target preview content sent by the external service layer of the server through the front end interface.

In some achievable implementations, the terminal device shows a target interface, wherein the target interface includes at least a candidate showing style, a material input control, and a cloud real machine option. The terminal device determines the target showing style according to the selected candidate showing style in response to a style configuration instruction; and the terminal device determines the material to be previewed according to a material uploaded to the material input control in response to a material input instruction; and the terminal device determines the target cloud real machine in response to a selection instruction for the cloud real machine option.

In some achievable implementations, the material to previewed includes an image; and material input control includes a sub-control for configuring images having different resolutions that is supported by the target showing style.

For the detailed description of the above implementations, a reference may be made to the related description on the embodiments of the material preview system, which will not be described redundantly here.

FIG. 8 is a flowchart of a material preview method illustrated according to yet another exemplary embodiment. As shown in FIG. 8, an embodiment of the present disclosure provides a material preview method which can be performed by the server shown in FIG. 1, particularly by a material preview apparatus which may be implemented by software and/or hardware and configured in the server. As shown in FIG. 8, the material preview method may include the following steps:
S810, acquiring a material to be previewed and target preview information, wherein the target preview information includes a target cloud real machine and an application for showing the material to be previewed, and a target showing style in which the application shows the material to be previewed; and
S820, rendering, according to the target cloud real machine and the application in combination with the target showing style, the material to be previewed to obtain a target preview content, wherein the target preview content is to be shown on a terminal device.

For the detailed description of the steps S810 to S820, a reference may be made to the related description of the above embodiments, which will not be described redundantly here.

In some achievable implementations, the material to be previewed and the target preview information are sent by the terminal device to the server, and the target cloud real machine is within an internal network, while the terminal device is within an external network. Correspondingly, the server receives, by an external service layer, the material to be previewed and the target preview information sent by the terminal device through a front end interface. The server pushes the material to be previewed and the target showing style to the target cloud real machine by the external service layer, and calls the target cloud real machine to render the material to be previewed with the application and the target showing style so as to obtain the target preview content. The server receives the target preview content sent by the target cloud real machine by the external service layer. The server sends the target preview content to the front end interface of the terminal device by the external service layer such that the terminal device shows the target preview content.

In some achievable implementations, the material to be previewed and the target preview information are sent by the terminal device to the server. Correspondingly, the server determines a user state of the target cloud real machine according to a mapping relationship between a cloud real machine and a terminal device. When the user state represents that the target cloud real machine is in an idle state, the server allocates the target cloud real machine to the terminal device and stores a mapping relationship between the target cloud real machine and the terminal device. If the target cloud real machine is no longer used by the terminal device, the server cancels the mapping relationship between the target cloud real machine and the terminal device.

In some achievable implementations, the server updates a version of an application installed in a cloud real machine and logs in to the updated application.

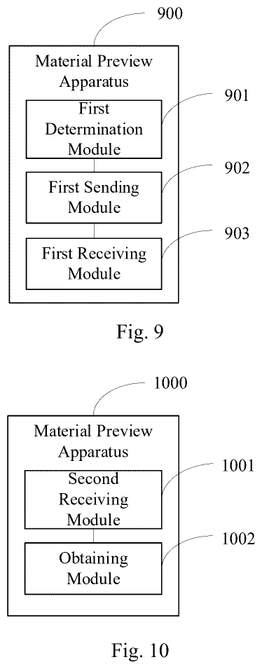

FIG. 9 is a schematic diagram of module connection of a material preview apparatus illustrated according to an exemplary embodiment. As shown in FIG. 9, an embodiment of the present disclosure provides a material preview apparatus 900. The material preview apparatus 900 is disposed in a terminal device and includes: a first determination module 901 configured to determine a material to be previewed and target preview information, wherein the target preview information includes a target cloud real machine and an application for showing the material to be previewed, and a target showing style in which the application shows the material to be previewed; a first sending module 902 configured to send the material to be previewed and the target preview information to a server, wherein the server is configured to render, according to the target cloud real machine and the application indicated by the target preview information in combination with the target showing style, the material to be previewed to obtain a target preview content, and send the target preview content to the terminal device; and a first receiving module 903 configured to receive the target preview content sent by the server, and show the target preview content.

Optionally, the target cloud real machine is in an internal network, and the terminal device is in an external network. The first sending module 902 is specifically configured to: send the material to be previewed and the target preview information to an external service layer of the server through a front end interface, wherein the external service layer is configured to push the material to be previewed and the target showing style to the target cloud real machine, and call the target cloud real machine to render the material to be previewed by the application and in the target showing style so as to obtain the target preview content.

The first receiving module 903 is specifically configured to: receive, through the front end interface, the target preview content sent by the external service layer of the server.

Optionally, the first determination module 901 is specifically configured to: show a target interface, wherein the target interface includes at least a candidate showing style, a material input control, and a cloud real machine option; determine the target showing style according to the selected candidate showing style in response to a style configuration instruction; determine the material to be previewed according to a material uploaded to the material input control in response to a material input instruction; and determine the target cloud real machine in response to a selection instruction for the cloud real machine option.

Optionally, the material to previewed includes an image; and material input control includes a sub-control for configuring images having different resolutions that is supported by the target showing style.

Regarding the logic of the material preview method performed by the functional modules of the material preview apparatus 900, a reference may be made to the related part of the material preview method in the above embodiments, which will not be described redundantly here.

FIG. 10 is a schematic diagram of module connection of a material preview apparatus illustrated according to an exemplary embodiment. As shown in FIG. 10, an embodiment of the present disclosure provides a material preview apparatus 1000. The material preview apparatus 1000 is disposed in a server and includes: a second receiving module 1001 configured to acquire a material to be previewed and target preview information, wherein the target preview information includes a target cloud real machine and an application for showing the material to be previewed, and a target showing style in which the application shows the material to be previewed; and an obtaining module 1002 configured to render, according to the target cloud real machine and the application in combination with the target showing style, the material to be previewed to obtain a target preview content, wherein the target preview content is to be shown on a terminal device.

Optionally, the material to be previewed and the target preview information are sent by the terminal device to the server, and the target cloud real machine is within an internal network, and the terminal device is within an external network. The second receiving module 1001 is specifically configured to: receive, by an external service layer, the material to be previewed and the target preview information sent by terminal device through a front end interface.

The obtaining module 1002 is specifically configured to: push the material to be previewed and the target showing style to the target cloud real machine by the external service layer, and call the target cloud real machine to render the material to be previewed by the application and in the target showing style so as to obtain the target preview content.

The obtaining module 1002 is further configured to: receive, by the external service layer, the target preview content sent by the target cloud real machine; and send, by the external service layer, the target preview content to the front end interface of the terminal device.

Optionally, the material to be previewed and the target preview information are sent by the terminal device to the server. The material preview apparatus 1000 further includes a mapping module configured to: determine a user state of the target cloud real machine according to a mapping relationship between a cloud real machine and a terminal device; when the use state represents that the target cloud real machine is in an idle state, allocate the target cloud real machine to the terminal device, and store a mapping relationship between the target cloud real machine and the terminal device; and when the target cloud real machine is no longer used by the terminal device, cancel the mapping relationship between the target cloud real machine and the terminal device.

Optionally, the material preview apparatus 1000 further includes an updating module configured to update a version of an application installed in a cloud real machine and log in to the updated application.

Regarding the logic of the material preview method performed by the functional modules of the material preview apparatus 1000, a reference may be made to the related part of the material preview method in the above embodiments, which will not be described redundantly here.

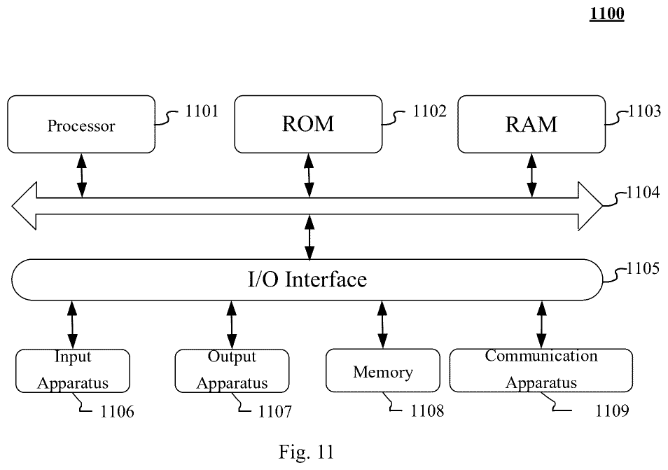

FIG. 11 is specifically referred below, and it shows the structure schematic diagram suitable for achieving the electronic device 1100 (such as the terminal device 101 and the server 102 in FIG. 1) in the embodiment of the present disclosure. The electronic device in the embodiment of the present disclosure may include but not be limited to a mobile terminal such as a mobile phone, a notebook computer, a digital broadcasting receiver, a personal digital assistant (PDA), a PAD (tablet computer), a portable multimedia player (PMP), a vehicle terminal (such as a vehicle navigation terminal), and a fixed terminal such as a digital television (TV) and a desktop computer. The electronic device shown in FIG. 11 is only an example and should not impose any limitations on the functions and use scopes of the embodiments of the present disclosure.

As shown in FIG. 11, the electronic device 1100 may include a processor (such as a central processing unit, and a graphics processor) 1101, it may execute various appropriate actions and processes according to a program stored in a read-only memory (ROM) 1102 or a program loaded from a memory 1108 to a random access memory (RAM) 1103. In RAM 1103, various programs and data required for operations of the electronic device 1100 are also stored. The processor 1101, ROM 1102, and RAM 1103 are connected to each other by a bus 1104. An input/output (I/O) interface 1105 is also connected to the bus 1104.

Typically, the following apparatuses may be connected to the I/O interface 1105: an input apparatus 1106 such as a touch screen, a touchpad, a keyboard, a mouse, a camera, a microphone, an accelerometer, and a gyroscope; an output apparatus 1107 such as a liquid crystal display (LCD), a loudspeaker, and a vibrator; a memory 1108 such as a magnetic tape, and a hard disk drive; and a communication apparatus 1109. The communication apparatus 1109 may allow the electronic device 1100 to wireless-communicate or wire-communicate with other devices so as to exchange data. Although FIG. 11 shows the electronic device 1100 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 1109, or installed from the memory 1108, or installed from ROM 1102. When the computer program is executed by the processor 1101, the above functions defined in the material preview method in the embodiments of the present disclosure are executed.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: determine a material to be previewed and target preview information, wherein the target preview information comprises a target cloud real machine and an application for showing the material to be previewed, and a target showing style in which the application shows the material to be previewed; send the material to be previewed and the target preview information to a server, wherein the server is configured to render, according to the target cloud real machine and the application indicated by the target preview information in combination with the target showing style, the material to be previewed to obtain a target preview content, and send the target preview content to the terminal device; and receive the target preview content sent by the server, and show the target preview content.

The above-mentioned computer-readable medium carries one or more programs, and when the one or more programs are executed by the electronic device, the electronic device is caused to: acquire a material to be previewed and target preview information, wherein the target preview information comprises a target cloud real machine and an application for showing the material to be previewed, and a target showing style in which the application shows the material to be previewed; and render, according to the target cloud real machine and the application in combination with the target showing style, the material to be previewed to obtain a target preview content, wherein the target preview content is to be shown on a terminal device.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

1. A material preview method, performed by a server and comprising:
acquiring a material to be previewed and target preview information, wherein the target preview information comprises a target cloud real machine and an application for showing the material to be previewed, and a target showing style in which the application shows the material to be previewed; and
rendering, according to the target cloud real machine and the application in combination with the target showing style, the material to be previewed to obtain a target preview content, wherein the target preview content is to be shown on a terminal device.

2. The material preview method according to claim 1, wherein the material to be previewed and the target preview information are sent by the terminal device to the server, the target cloud real machine is in an internal network, and the terminal device is in an external network; the acquiring a material to be previewed and target preview information comprises:
receiving, by an external service layer, the material to be previewed and the target preview information sent by the terminal device through a front end interface; and
the rendering, according to the target cloud real machine and the application in combination with the target showing style, the material to be previewed to obtain a target preview content comprises:
pushing the material to be previewed and the target showing style to the target cloud real machine by the external service layer, and calling the target cloud real machine to render the material to be previewed with the application and the target showing style so as to obtain the target preview content;
the material preview method further comprises:
receiving, by the external service layer, the target preview content sent by the target cloud real machine; and
sending, by the external service layer, the target preview content to the front end interface of the terminal device to allow the terminal device to show the target preview content.

3. The material preview method according to claim 1, wherein the material to be previewed and the target preview information are sent by the terminal device to the server; the material preview method further comprises:
determining a user state of the target cloud real machine according to a mapping relationship between a cloud real machine and a terminal device;
when the use state represents that the target cloud real machine is in an idle state, allocating the target cloud real machine to the terminal device, and storing a mapping relationship between the target cloud real machine and the terminal device; and
when the target cloud real machine is no longer used by the terminal device, canceling the mapping relationship between the target cloud real machine and the terminal device.

4. The material preview method according to claim 1, further comprising:
updating a version of an application installed in the target cloud real machine and logging in to the updated application.

5. A material preview method, performed by a terminal device and comprising:
determining a material to be previewed and target preview information, wherein the target preview information comprises a target cloud real machine and an application for showing the material to be previewed, and a target showing style in which the application shows the material to be previewed;
sending the material to be previewed and the target preview information to a server, wherein the server is configured to render, according to the target cloud real machine and the application indicated by the target preview information in combination with the target showing style, the material to be previewed to obtain a target preview content, and send the target preview content to the terminal device; and
receiving the target preview content sent by the server, and showing the target preview content.

6. The material preview method according to claim 5, wherein the target cloud real machine is in an internal network, and the terminal device is in an external network; the sending the material to be previewed and the target preview information to a server comprises:
sending the material to be previewed and the target preview information to an external service layer of the server through a front end interface, wherein the external service layer is configured to push the material to be previewed and the target showing style to the target cloud real machine, and call the target cloud real machine to render the material to be previewed with the application and the target showing style so as to obtain the target preview content; and
the receiving the target preview content sent by the server comprises:
receiving, through the front end interface, the target preview content sent by the external service layer of the server.

7. The material preview method according to claim 5, wherein the determining a material to be previewed and target preview information comprises:
showing a target interface, wherein the target interface at least comprises a candidate showing style, a material input control, and a cloud real machine option;
determining the target showing style according to a selected candidate showing style in response to a style configuration instruction;
determining the material to be previewed according to a material uploaded to the material input control in response to a material input instruction; and
determining the target cloud real machine in response to a selection instruction for the cloud real machine option.

8. The material preview method according to claim 7, wherein the material to be previewed comprises an image; and the material input control comprises a sub-control for configuring images having different resolutions that is supported by the target showing style.

9. A material preview method, applied to a material preview system comprising a terminal device and a server, the material preview method comprising:
determining, by the terminal device, a material to be previewed and target preview information, wherein the target preview information comprises a target cloud real machine and an application for showing the material to be previewed, and a target showing style in which the application shows the material to be previewed;
sending, by the terminal device, the material to be previewed and the target preview information to the server;
receiving, by the server, the material to be previewed and the target preview information sent by the terminal device;
rendering, by the server according to the target cloud real machine and the application in combination with the target showing style, the material to be previewed to obtain a target preview content;
sending, by the server, the target preview content to the terminal device; and
receiving, by the terminal device, the target preview content sent by the server, and showing the target preview content.

10. A non-transitory computer-readable medium, storing a computer program which, when executed by a processor, causes the material preview method according to claim 1 to be implemented.

11. The medium according to claim 10, wherein the material to be previewed and the target preview information are sent by the terminal device to the server, the target cloud real machine is in an internal network, and the terminal device is in an external network; the acquiring a material to be previewed and target preview information comprises:
receiving, by an external service layer, the material to be previewed and the target preview information sent by the terminal device through a front end interface; and
the rendering, according to the target cloud real machine and the application in combination with the target showing style, the material to be previewed to obtain a target preview content comprises:
pushing the material to be previewed and the target showing style to the target cloud real machine by the external service layer, and calling the target cloud real machine to render the material to be previewed with the application and the target showing style so as to obtain the target preview content;
the material preview method further comprises:
receiving, by the external service layer, the target preview content sent by the target cloud real machine; and
sending, by the external service layer, the target preview content to the front end interface of the terminal device to allow the terminal device to show the target preview content.

12. The medium according to claim 10, wherein the material to be previewed and the target preview information are sent by the terminal device to the server; the material preview method further comprises:
determining a user state of the target cloud real machine according to a mapping relationship between a cloud real machine and a terminal device;
when the use state represents that the target cloud real machine is in an idle state, allocating the target cloud real machine to the terminal device, and storing a mapping relationship between the target cloud real machine and the terminal device; and
when the target cloud real machine is no longer used by the terminal device, canceling the mapping relationship between the target cloud real machine and the terminal device.

13. The medium according to claim 10, wherein the material preview method further comprising:
updating a version of an application installed in the target cloud real machine and logging in to the updated application.

14. An electronic device, comprising:
a memory on which a computer program is stored; and
a processor configured to execute the computer program on the memory to implement the material preview method according to claim 1.

15. The electronic device according to claim 14, wherein the material to be previewed and the target preview information are sent by the terminal device to the server, the target cloud real machine is in an internal network, and the terminal device is in an external network; the acquiring a material to be previewed and target preview information comprises:
receiving, by an external service layer, the material to be previewed and the target preview information sent by the terminal device through a front end interface; and
the rendering, according to the target cloud real machine and the application in combination with the target showing style, the material to be previewed to obtain a target preview content comprises:
pushing the material to be previewed and the target showing style to the target cloud real machine by the external service layer, and calling the target cloud real machine to render the material to be previewed with the application and the target showing style so as to obtain the target preview content;
the material preview method further comprises:
receiving, by the external service layer, the target preview content sent by the target cloud real machine; and
sending, by the external service layer, the target preview content to the front end interface of the terminal device to allow the terminal device to show the target preview content.

16. The electronic device according to claim 14, wherein the material to be previewed and the target preview information are sent by the terminal device to the server; the material preview method further comprises:
determining a user state of the target cloud real machine according to a mapping relationship between a cloud real machine and a terminal device;
when the use state represents that the target cloud real machine is in an idle state, allocating the target cloud real machine to the terminal device, and storing a mapping relationship between the target cloud real machine and the terminal device; and
when the target cloud real machine is no longer used by the terminal device, canceling the mapping relationship between the target cloud real machine and the terminal device.

17. The medium according to claim 14, wherein the material preview method further comprising:
updating a version of an application installed in the target cloud real machine and logging in to the updated application.
